(19) United States
(12) Patent Application Publication
(10) Pub. No.: US 2011/0318603 A1
(43) Pub. Date: Dec. 29, 2011

(54) MAGNESIUM ALLOY MEMBER

(75) Inventors: Nobuyuki Okuda, Osaka (JP); Masatada Numano, Osaka (JP); Nozomu Kawabe, Osaka (JP); Takahiko Kitamura, Osaka (JP); Yukihiro Oishi, Osaka (JP)

(73) Assignee: SUMITOMO ELECTRIC INDUSTRIES, LTD., OSAKA-SHI OSAKA (JP)

(21) Appl. No.: 13/203,871

(22) PCT Filed: Mar. 3, 2010
(86) PCT No.: PCT/JP2010/053430

§ 371 Date: Aug. 30, 2011

(30) Foreign Application Priority Data
Mar. 12, 2009 (JP) 2009-060151

(51) Int. Cl. B21D 39/00; B32B 15/00

(52) U.S. Cl. 428/621; 428/650

(57) ABSTRACT

A magnesium alloy structural member includes a base material composed of a magnesium alloy having an aluminum content of 4.5% by mass to 11% by mass, in which the base material has a pair of first and second surfaces, the first surface and the second surface being opposite each other, in which when a distance between the first surface and the second surface is defined as a thickness and when surface area regions are defined as regions extending from the first and second surfaces to positions 20 μm from the respective first and second surfaces in the thickness direction, in at least both the surface area regions, 10 or more fine precipitates are present in any 20 μm×20 μm subregion of each of the surface area regions, each of the fine precipitates containing both Mg and Al and having a greatest dimension of 0.5 μm to 3 μm. Because at least each of the surface area regions is composed of a microscopic texture in which fine precipitates are dispersed, the magnesium alloy structural member has excellent corrosion resistance without anticorrosion treatment and can be used for housings and so forth.

### TECHNICAL FIELD

The present invention relates to a magnesium alloy structural member suitable for housings, various parts, and so forth. In particular, the present invention relates to a magnesium alloy structural member having excellent corrosion resistance.

### BACKGROUND ART

Magnesium alloys containing various additive elements have been used as materials for housings of mobile electronic devices, such as cellular phones and notebook personal computers, and members, such as parts of automobiles.

A magnesium alloy has a hexagonal crystal structure (hexagonal close-packed structure) and poor plastic formability at ordinary temperature. So, magnesium alloy structural members used for, for example, housings as described above are mainly made of cast materials produced by a die casting method or a thixomold method. The formation of housings by subjecting a sheet composed of an AZ31 alloy according to the American Society for Testing and Materials (ASTM) standard to press working has recently been studied. Patent Literature 1 reports a sheet which is composed of an alloy corresponding to an AZ91 alloy according to the ASTM standard and which has excellent press workability.

Magnesium alloys are active metals. So, surfaces of the members described above are usually subjected to anticorrosion treatment, e.g., anodic-oxidation treatment or chemical-conversion treatment.

### SUMMARY OF INVENTION

### Technical Problem

For an Al-containing magnesium alloy, a higher Al content tends to provide higher corrosion resistance. The AZ91 alloy has high corrosion resistance among magnesium alloys. However, even in the case of a magnesium alloy structural member including a base material composed of the AZ91 alloy, the base material needs to be subjected to anticorrosion treatment. Furthermore, in order to improve the corrosion resistance and so forth, painting is usually performed in addition to the anticorrosion treatment. If the base material of the magnesium alloy is exposed by the formation of a dent due to a drop or the detachment of the paint due to heavy use, corrosion proceeds from the exposed portion. So, the base material itself composed of the magnesium alloy is required to have excellent corrosion resistance.

Accordingly, it is an object of the present invention to provide a magnesium alloy structural member having high corrosion resistance.

### Solution to Problem

The inventors have studied a magnesium alloy having a relatively high Al content and have found that with respect to a base material, when at least fine precipitates are dispersed in a surface portion that is likely to come into contact with air or moisture, which causes corrosion, the base material itself has increased corrosion resistance. In the case of a magnesium alloy having a relatively high Al content, precipitates each containing both Mg and Al are likely to be formed. However, the relationship between corrosion resistance and the size and present state of precipitates has not been sufficiently investigated. The inventors have conducted studies and have found that as described above, when fine precipitates each having a specific size are present in textures of at least surface portions of a base material, the base material has excellent corrosion resistance and can be sufficiently used without anticorrosion treatment, which had been essential in the past. This finding has led to the completion of the present invention.

A magnesium alloy structural member according to the present invention includes a base material composed of a magnesium alloy having an aluminum (Al) content of 4.5% by mass to 11% by mass. The base material has a pair of first and second surfaces, the first surface and the second surface being opposite each other. When a distance between the first surface and the second surface is defined as a thickness and when surface area regions are defined as regions extending from the first and second surfaces to positions 20 μm from the respective first and second surfaces in the thickness direction, in at least both the surface area regions, 10 or more fine precipitates described below are present in any 20 μm×20 μm subregion of each of the surface area regions.

Fine precipitates: precipitates containing both Mg and Al and each having a greatest dimension of 0.5 μm to 3 μm.

According to the foregoing structure, at least the surface portion of the base material is composed of the magnesium alloy having the texture in which the fine precipitates are dispersed. So, the base material has excellent corrosion resistance and can be used without anticorrosion treatment. Thus, as a typical embodiment of the present invention, a configuration of the base material alone, i.e., each of the first and second surfaces of the base material is not subjected to anticorrosion treatment, may be exemplified. According to this embodiment, it is possible to eliminate an anticorrosion treatment step, which has been essential in the past, thereby improving the productivity of the magnesium alloy structural member. Furthermore, as an embodiment of the present invention, the magnesium alloy structural member includes the base material and a painted layer that is arranged on only one of the first and second surfaces of the base material, in which the painted layer is arranged directly on the one surface that is not subjected to the anticorrosion treatment. According to this embodiment, the arrangement of the painted layer enhances the corrosion resistance of the magnesium alloy structural member and can impart color or a pattern thereto, which increases the commercial value.

### Advantageous Effects of Invention

The magnesium alloy structural member according to the present invention has excellent corrosion resistance.

### BRIEF DESCRIPTION OF DRAWINGS

FIG. 1 illustrates scanning electron microscope photographs of surface portions of cross sections of magnesium alloy structural members, part (I) of FIG. 1 illustrates sample No. 15, and part (II) of FIG. 1 illustrates sample No. 105.

### DESCRIPTION OF EMBODIMENTS

The present invention will be described in more detail below.

### [Base Material]

### <<Composition>>

Examples of a magnesium alloy constituting a base material include magnesium alloys having various compositions and each at least containing 4.5% by mass to 11% by mass Al serving as an additive element (remainder: Mg and impurities). Examples of the additive element other than Al include Zn (0.2% to 7.0% by mass), Mn (0.05% to 0.5% by mass), Zr (0.1% to 1.0% by mass), Si (0.2% to 1.4% by mass), rare-earth metals (RE, excluding Y, 1.0% to 3.5% by mass), Y (1.0% to 6.0% by mass, Ag (0.5% to 3.0% by mass), Ca (0.2% to 6.0% by mass), Cu (0.2% to 3.0% by mass), Ce (0.05 to 1.0 mass), and Sr (0.2% to 7.0% by mass). Examples of an alloy having a composition in which Al and at least one element selected from these elements are contained in the above ranges include AZ-based alloys (Mg—Al—Zn alloys, Zn: 0.2% to 1.5% by mass), AM-based alloys (Mg—Al—Mn-based alloys, Mn: 0.15% to 0.5% by mass), As-based alloys (Mg—Al—Si-based alloys, Si: 0.6% to 1.4% by mass), Mg—Al-rare-earth element (RE) alloys, AX-based alloys (Mg—Al—Ca-based alloys, Ca: 0.2% to 6.0% by mass), and AJ-based alloys (Mg—Al—Sr-based alloys, Sr: 0.2% to 7.0% by mass) according to the ASTM standards. Among Mg—Al—Zn-based alloys, in particular, an AZ61 alloy, an AZ80 alloy, an AZ81 alloy, and an AZ91 alloy have suitable compositions. Among Mg—Al—Mn-based alloys, for example, an AM60 alloy and an AM100 alloy have suitable compositions. An AZ91 alloy is particularly preferred because of its excellent corrosion resistance.

For a magnesium alloy containing Al in the above range, a higher Al content (hereinafter, referred to as an “Al content”) results in higher corrosion resistance and excellent mechanical properties, such as strength. However, at an excessively high Al content, plastic formability is liable to decrease. So, the upper limit is set to 11% by mass. In view of corrosion resistance, mechanical properties, and formability, the Al content is more preferably in the range of 5.8% by mass to 10% by mass.

### <<Configuration>>

The base material composed of the magnesium alloy has a configuration such that at least a pair of first and second surfaces is provided, the first and second surfaces being opposite each other. When an observer views the magnesium alloy structural member according to the present invention from a certain direction, the first and second surfaces correspond to a surface placed in front of the observer and a surface opposite the surface. Typically, the two surfaces are parallel to each other. Typical examples of the configuration include a sheet; and a sheet-processed material having a three-dimensional configuration obtained by subjecting a sheet to plastic working, for example, press working (including punching), bending work, or forge processing. Examples of the sheet-processed material include a bracket-shaped material having a bottom and a side wall extending upright from the bottom; and a box-shaped material. For each of the sheet and the sheet-processed material, the first and second surfaces of the base material correspond to front and back sides when used. Each of the first and second surfaces may be a flat surface or a curved surface. A distance between the first and second surfaces is defined as a thickness. In particular, when the thickness is in the range of about 0.3 mm to about 3.0 mm, the base material can be suitably used for members for housings of electronic devices, transport machines, such as motor vehicles, trains, and airplanes, and so forth.

Examples of the foregoing sheet include rolled materials produced by rolling cast materials; and treated materials produced by subjecting rolled materials to, for example, heat treatment, leveling processing, or polishing processing. Examples of the sheet-processed material also include materials produced by subjecting sheet-processed materials to heat treatment or polishing processing after plastic working. Examples of the magnesium alloy structural member according to the present invention also include treated materials and sheet-processed materials provided with painted layers described below. A cast material can be subjected to plastic working, for example, rolling or press working, to form a rolling texture or the like, instead of a metal texture. Furthermore, a base material having a microscopic texture with an average crystal grain size of 20 μm or less can be formed. The presence of the microscopic texture is likely to lead to a texture containing fine precipitates uniformly dispersed. Moreover, the base material subjected to plastic working, for example, rolling or press working can have excellent mechanical properties, such as strength, less internal defects and surface defects, such as a shrinkage cavities and pores, and a satisfactory surface texture, compared with those of cast materials.

### <<Texture>>

### <Precipitates>

When surface area regions are defined as surface portions of the base material, specifically, when surface area regions are defined as a region extending from the first surface of the base material to a position 20 μm from the first surface in the thickness direction and a region extending from the second surface of the base material to a position 20 μm from the second surface. More specifically, in any subregion (20 μm×20 μm) of each of the surface area regions including the first and second surfaces serving as outermost surfaces of the base material, when the grain size of each of the precipitates present in one subregion is measured and when the greatest dimension of each precipitate is measured, 10 or more fine precipitates each having a greatest dimension of 0.5 μm to 3 μm are present in one subregion. If the number of the fine precipitates is less than 10, the base material has poor corrosion resistance and cannot be used as it is. So the base material needs to be subjected to anticorrosion treatment. The precipitates are typically composed of a material containing both Mg and Al, for example, an intermetallic compound, such as Mg₁₇Al₁₂. A larger number of the fine precipitates have a tendency to lead to higher corrosion resistance. More preferably, 20 or more fine precipitates are present in the subregion (20 μm×20 μm). However, an excessively larger number of the precipitates can cause a reduction in the Al content of a mother phase to fail to satisfy a predetermined composition, thereby reducing the strength. Thus, the fine precipitates are preferably present to the extent that the mother phase satisfies the predetermined composition. In the present invention, a precipitate having a greatest dimension of less than 0.5 μm and a precipitate having a greatest dimension exceeding 3 μm are allowed to be present. The presence of only precipitates having a greatest dimension of less than 0.5 μm is less likely to contribute to improvement in corrosion resistance. The presence of precipitates having a greatest dimension exceeding 3 μm causes cracking during plastic working and is preferably minimized.

In addition to the surface area regions of the base material, when a region extending from the first or second surface to a position exceeding 20 μm from the first or second surface in the thickness direction has a texture in which the fine precipitates are dispersed, the base material tends to have higher corrosion resistance. Thus, a region where the fine precipitates are dispersed preferably extends from the first or second surface to a position 5% of the thickness, more preferably 40% of the thickness, and still more preferably the whole thickness of the base material from the first or second surface in the thickness direction. More specifically, the region where the fine precipitates are dispersed preferably extends from the first or second surface to a position 0.1 mm or more and more preferably 0.2 mm or more from the first or second surface in the thickness direction.

### <<Corrosion Resistance>>

As described above, the base material has excellent corrosion resistance. On each of the first and second surfaces of the base material, the proportion of a corroded area 100 hours after salt spray testing (Japanese Industrial Standards (JIS) Z 2371, 2000) is 10% or less. In particular, for a base material composed of a magnesium alloy having a high Al content, for example, the AZ80 alloy, the AZ81 alloy, the AZ91 ally, or a magnesium alloy having an Al content comparable to these alloys, the corrosion resistance is further increased, and the proportion of the corroded area is 5% or less.

### <<Surface Electrical Resistance Value>>

The base material does not have a portion subjected to anticorrosion treatment. A matrix metal is exposed as it is, except when a covering layer described below is provided. So, the base material has a low surface electrical resistance value. On each of the first and second surfaces, the surface electrical resistance value measured by a two-point probe method is 1 Ω·cm or less. Furthermore, the base material has excellent corrosion resistance. So, the surface electrical resistance value 100 hours after the salt spray testing (JIS Z 2371, 2000) is 30 Ω·cm or less. In particular, for a base material composed of a magnesium alloy having a high Al content, for example, the AZ80 alloy, the AZ81 alloy, the AZ91 ally, or a magnesium alloy having an Al content comparable to these alloys, the corrosion resistance is further increased, and the surface electrical resistance value 100 hours after the salt spray testing is 20 Ω·cm or less. Because the base material has a low surface electrical resistance value, if the magnesium alloy structural member according to the present invention is used as a housing of an electronic device, a ground can be established using the base material. Furthermore, because the base material has excellent corrosion resistance, a ground can be stably established in the usage environment of an electronic device. In the case where a painted layer is provided on one of the first and second surfaces, a ground can be established using the other surface.

### <<Others>>

As described above, because anticorrosion treatment is not performed, an element, e.g., phosphorus (P), attributed to an anticorrosion treatment agent is not substantially present on each of the first and second surfaces of the base material. Specifically, the concentration of phosphorus (P) on each of the first and second surfaces of the base material is 0.01% by mass or less.

### [Covering Layer]

On one of the first and second surfaces of the base material, in particular, on one surface of a housing or the like, a covering layer may be arranged. Because the base material is not subjected to anticorrosion treatment as described above, the covering layer is arranged directly on one surface of the base material. The painted layer preferably has excellent corrosion resistance and surface hardness. Various painted layers that have been used for magnesium alloy structural members may be used. To form the painted layer, any of wet processes (e.g., a dipping process, spray coating, and electrodeposition coating) dry methods (e.g., a physical vapor deposition (PVD) method and a chemical vapor deposition (CVD) method) may be employed. The color (the painted layer may be colorless or colored), design, thickness, and so forth of the painted layer may be appropriately selected, depending on desired applications and so forth. In the case where the painted layer is formed over the one surface, masking is preferably performed on the other surface on which a painted layer is not formed (a reverse side of the housing or the like).

### [Another Processing]

In the case where at least one of the first and second surfaces of the base material, in particular, a surface of a housing or the like, is subjected to fine asperity-forming processing (with a depth of about 1 μm to about 200 μm) by at least one selected from a hairline finish, a diamond cut finish, a spin cut finish, shot blast processing, end mill machining, and an etching procedure, the metallic texture is improved to increase the commercial value of the magnesium alloy structural member. In particular, the magnesium alloy structural member according to the present invention is not subjected to anticorrosion treatment or the formation of painted layer as described above. So, the original metallic texture can be provided. In the case where a painted layer is arranged, the use of a transparent (colored or colorless) painted layer having a thickness of 30 μm or less is likely to improve the metallic texture. In the case of producing a sheet-processed material by subjecting the foregoing sheet to press working or the like, shot blast processing, the hairline finish, and the spin cut finish may be performed before or after the press working or the like. The diamond cut finish, the end mill machining, and the etching procedure are preferably performed for the sheet before the press working because they are easily performed on a flat surface.

A portion formed by the hairline finish (hereinafter, referred to as a finished portion) has higher surface roughness than a portion that is not subjected to hairline finish (hereinafter, referred to as an unfinished portion) to some extent. The unfinished portion is smooth and has metallic luster. In this situation, a contrast between roughness and smoothness can improve the metallic texture. The surface roughness Ry (maximum height, JIS B 0031, 1994) in the direction perpendicular to lines in the finished portion is preferably in the range of 0.4 μM to 10 μm. The surface roughness Ry in the direction parallel to the lines in the unfinished portion is preferably in the range of 0.1 to 0.3 μm. For the diamond cut finish, the angle between two planes formed by the finish is preferably in the range of 55° to 150°, the depth is preferably in the range of 5 μm to 100 μm, and the pitch of asperities is preferably in the range of 50 μm to 400 μm. For the etching procedure, in the case where the etch depth is set in the range of 0.1 μm to 50 μm and where the ratio of the surface roughness A (maximum roughness Ry) in an etched portion to the surface roughness B (maximum roughness Ry) in an unetched portion is set to A/B, the ratio A/B is preferably in the range of 0.01 to 100. The end mill machining enables us to provide various shapes, compared with the diamond cut finish.

### [Production Method]

As described above, the base material in which at least each of the surface area regions has a texture containing fine precipitates dispersed is typically produced by rolling a cast material.

### <<Casting>>

With respect to the cast material, a cast material having a microscopic texture with a small average crystal grain size is obtained by, for example, performing rapid cooling with a cooling medium having a high cooling capacity, such as liquid nitrogen, in a cooling process of a billet casting. Alternatively, a cast billet produced under normal conditions can be used. In the case of using this cast billet, after rolling described below is performed, surface treatment described below is performed, thereby providing the base material. A cast material produced by a continuous casting process, such as a twin-roll process in which rapid solidification can be performed, can also be used. In the continuous casting process, oxides and segregation are reduced. Furthermore, a cast material having a microscopic texture with a small average crystal grain size is obtained by rapid cooling. Moreover, the cast material obtained by the continuous casting process is excellent in plastic formability when subjected to rolling or the like. In addition, coarse crystalline precipitates each having a grain size of more than 10 μm can be reduced by rolling. In any of these cast materials described above, when the thickness is 20 mm or less, a microscopic texture is easily obtained, and the segregation is easily reduced. Furthermore, for any cast material, the casting process (including the cooling process) is preferably performed in an inert gas atmosphere, for example, argon (Ar) or nitrogen (N₂), in order to prevent the oxidation of a magnesium alloy.

### <<Rolling>>

Rolling conditions are as follows: for example, a heating temperature of a material of 200° C. to 400° C.; a heating temperature of rolling mill rolls of 150° C. to 300° C.; and a rolling reduction per pass of 5% to 50%. Multipass rolling is preferably performed in such a manner that a desired thickness is achieved. When the cast material is subjected to such rolling, a microscopic texture having an average crystal grain size of 20 μm or less is easily obtained. Furthermore, segregation, internal defects, surface defects, and so forth during casting are reduced, thereby providing a rolled material having an excellent surface texture. After final rolling, final heat treatment is performed to provide a fine recrystallized texture having an average crystal grain size of 20 μm or less, thereby enhancing the corrosion resistance and strength of the resulting cast material. The rolled material may be subjected to leveling processing or polishing processing, thereby leveling the orientation of crystal grains and smoothing the surface.

### <<Surface Treatment>>

An example of surface treatment to which a rolled material obtained by rolling the cast billet is subjected is to irradiate a surface portion of the rolled material with, for example, laser light to locally melt the surface portion and then to blow an inert gas, for example, argon (Ar) or nitrogen (N₂) in an inert gas atmosphere, for example, Ar or N₂. The temperature of the blown gas may be sufficiently lower than a temperature at which the surface portion is melted. For example, the temperature of the inert gas may be equal to room temperature. When the temperature of the inert gas is lower than room temperature, the cooling rate of the melted surface portion can be further increased. This surface treatment makes it possible to reduce the average crystal grain size of at least each of the first and second surfaces of the base material and provide a texture in which the fine precipitates are dispersed.

### <<Plastic Working>>

In the case where the sheet-processed material is produced, the rolled material (including a material subjected to heat treatment and so forth) is subjected to plastic working, for example, press working, deep-drawing processing, forge processing, blow forming, or bending work. In particular, the plastic working at 200° C. to 280° C. inhibits the texture of the rolled material from being changed into a coarse recrystallized texture, thereby preventing the degradation of corrosion resistance and mechanical properties. Heat treatment may be performed after the plastic working. In the case where the painted layer is provided, the painted layer is preferably formed after the plastic working.

Embodiments of the present invention will be described below.

Sheets were produced from ingots (all commercially available) composed of magnesium alloys described in Table 1 under various production conditions. Texture observation, a corrosion test, and the measurement of a surface electrical resistance value of the resulting magnesium alloy sheets were performed. The production conditions are described below.

### (Condition A)

An ingot composed of a magnesium alloy is heated to 700° C. in an inert atmosphere (N₂ or Ar atmosphere) to form a molten metal. The resulting molten metal is rapidly cooled with liquid nitrogen as a cooling medium in the inert atmosphere to form a rapidly cooled billet material measuring 250 mm by 300 mm by 20 mm thick by casting. The resulting rapidly cooled billet material is subjected to multipass warm rolling (the heating temperature of the material: 200° C. to 400° C., the heating temperature of rolling mill rolls: 150° C. to 300° C., and the rolling reduction per pass: 5% to 50%) to produce a sheet having a thickness of 1 mm. The resulting sheet is used as a sample.

### (Condition B)

An ingot composed of a magnesium alloy is heated to 700° C. in an inert atmosphere (N₂ or Ar atmosphere) to form a molten metal. A billet material measuring 250 mm by 300 mm by 20 mm thick is formed by casting the molten metal in the inert atmosphere. The resulting billet material is subjected to multipass warm rolling (the heating temperature of the material: 200° C. to 400° C., the heating temperature of rolling mill rolls: 150° C. to 300° C., and the rolling reduction per pass: 5% to 50%) to produce a rolled sheet having a thickness of 0.8 mm. A surface of the resulting rolled sheet is irradiated with laser light in the inert atmosphere to melt a surface portion of the rolled sheet. Rapid cooling is performed by blowing an inert gas (N₂ or Ar, room temperature). The resulting sheet is used as a sample.

### (Condition C)

An ingot composed of a magnesium alloy is heated to 700° C. in an inert atmosphere (N₂ or Ar atmosphere) to form a molten metal. A cast sheet measuring 250 mm by 600 mm by 5 mm thick is formed by a twin-roll casting process using the molten metal. The resulting cast sheet is subjected to multipass warm rolling (the heating temperature of the material: 200° C. to 400° C., the heating temperature of rolling mill rolls: 150° C. to 300° C., and the rolling reduction per pass: 5% to 50%) to produce a sheet having a thickness of 0.6 mm.

### (Condition D)

An ingot composed of a magnesium alloy is heated to 700° C. in an inert atmosphere (N₂ or Ar atmosphere) to form a molten metal. A billet material measuring 250 mm by 300 mm by 20 mm thick is formed by casting the molten metal in the inert atmosphere. The resulting billet material is subjected to multipass warm rolling (the heating temperature of the material: 200° C. to 400° C., the heating temperature of rolling mill rolls: 150° C. to 300° C., and the rolling reduction per pass: 5% to 50%) to produce a rolled sheet having a thickness of 0.8 mm. The resulting rolled sheet is used as a sample.

To uniformize the composition, heat treatment (solution heat treatment) or aging treatment may be performed after casting. An intermediate heat treatment may be performed in the course of rolling. Final heat treatment may be performed after final rolling.

For each of the resulting samples (sheets), the number of fine precipitates (number/20 μm×20 μm=400 μm²), the thickness (mm) of a region where the fine precipitates were dispersed, the proportion (%) of a corroded area 100 hours after salt spray testing, and the surface electrical resistance value (Ω·cm) were measured. Table 1 shows the results.

The number of the fine precipitates is determined as follows: The cross section of each sheet sample is observed with a scanning electron microscope (SEM) (×200 to ×2000 magnification). In each observation image, a region extending from one surface to a position 20 μm from the one surface in the thickness direction is defined as a surface area region. Five 20 μm×20 μm subregions are randomly selected from the surface area region. The dimensions of all precipitates present in each subregion are measured. The precipitates are determined by their compositions. After the cross section is subjected to mirror polishing, compositions of particles present in the cross section are determined by a qualitative analysis, such as energy dispersive X-ray spectroscopy (EDX), and a semi-qualitative analysis. Particles containing Al and Mg are defined as precipitates. A straight line parallel to the cross section is drawn on each of the precipitates in the cross section. The maximum length of each straight line that cut across the corresponding precipitate is defined as the greatest dimension of the precipitate. Precipitates each having a greatest dimension of 0.5 μm to 3 μm are defined as fine precipitates in the subregion. The average number of the fine precipitates present in the five subregions is defined as the number of fine precipitates.

The thickness of a region where the fine precipitates are dispersed is determined as follows: The cross section of each sheet sample is observed with a scanning electron microscope (SEM) (×200 to ×2000 magnification). In each observation image, any 20 μm×20 μm subregion in a region extending from one surface in the thickness direction is set. The number of fine precipitates is determined as described above. A boundary where the number of fine precipitates is comparable to the number of fine precipitates in the surface area region is determined. A thickness from the one surface to the boundary is defined as the thickness of the region where the fine precipitates are dispersed.

The proportion of a corroded area is determined as follows: According to Salt Spray Testing (SST, JIS Z 2371 (2000)), the samples are placed in a testing chamber set at 35° C. and sprayed with 5% salt water. After a lapse of 100 hours in the testing chamber, the corroded area of one surface of each sample is measured. The corroded portion turns black or white, compared with an unchanged portion. So, the one surface is photographed, and then the resulting image is subjected to image processing or the like. In this way, the corroded area is easily determined. The ratio of the corroded area to the total area of the one surface of each sample is defined as the proportion of the corroded area.

The surface electrical resistance value is determined as follows: After the salt spray testing (100 hours) under the same conditions as those in the measurement of the corroded area, any five points on one surface of each sample are selected. The surface electrical resistance values are measured three times for each selected point (per point). An average value at five points is defined as the surface electrical resistance value of the sample. The surface electrical resistance value is measured with Loresta (manufactured by Mitsubishi Chemical Corporation) using two-point-probe-type MCP-TPAP by a two-point probe method.

TABLE 1

| Sample | Production | Type of alloy | Number of fine | | Proportion of | Surface electrical |
|---|---|---|---|---|---|---|
| No. | condition | composition | precipitates | Thickness | corroded area | resistance value |
| 1 | (A) | AZ61 | 15 | 0.2 mm | 7% | 28 Ω · cm |
| 2 | (A) | AM60 | 12 | 0.4 mm | 8% | 25 Ω · cm |
| 3 | (A) | AZ80 | 17 | 0.2 mm | 4% | 17 Ω · cm |
| 4 | (A) | AZ81 | 13 | 0.3 mm | 2% | 15 Ω · cm |
| 5 | (A) | AZ91 | 12 | 0.3 mm | 1% | 10 Ω · cm |
| 6 | (B) | AZ61 | 11 | 0.2 mm | 4% | 26 Ω · cm |
| 7 | (B) | AM60 | 13 | 0.3 mm | 7% | 23 Ω · cm |
| 8 | (B) | AZ80 | 16 | 0.1 mm | 5% | 12 Ω · cm |
| 9 | (B) | AZ81 | 12 | 0.2 mm | 3% | 13 Ω · cm |
| 10 | (B) | AZ91 | 14 | 0.1 mm | 2% | 12 Ω · cm |
| 11 | (C) | AZ61 | 14 | 0.3 mm | 5% | 23 Ω · cm |
| 12 | (C) | AM60 | 16 | 0.3 mm | 6% | 21 Ω · cm |
| 13 | (C) | AZ80 | 17 | 0.3 mm | 2% | 13 Ω · cm |
| 14 | (C) | AZ81 | 16 | 0.3 mm | 1% | 11 Ω · cm |
| 15 | (C) | AZ91 | 21 | 0.3 mm | 1% | 9 Ω · cm |
| 16 | (C) | AX52 | 15 | 0.3 mm | 1% | 23 Ω · cm |
| 17 | (C) | AJ62 | 14 | 0.3 mm | 1% | 20 Ω · cm |
| 101 | (D) | AZ61 | 3 | 0.4 mm | 80% | 1M Ω · cm or more |
| 102 | (D) | AM60 | 4 | 0.4 mm | 60% | 1M Ω · cm or more |
| 103 | (D) | AZ80 | 2 | 0.4 mm | 75% | 1M Ω · cm or more |
| 104 | (D) | AZ81 | 7 | 0.4 mm | 55% | 1M Ω · cm or more |
| 105 | (D) | AZ91 | 7 | 0.4 mm | 35% | 1k Ω · cm or more |

Table 1 demonstrates that for each sample composed of a magnesium alloy containing 4.5% to 11% by mass Al and having a texture in which 10 or more fine precipitates with a size of 0.5 μm to 3 μm are dispersed in the 20 μm×20 μm region of at least the surface portion, the proportion of the corroded area is as low as 10% or less. That is, these samples have excellent corrosion resistance. Furthermore, in each of the samples with excellent corrosion resistance, a region extending from one surface of the sheet to a position exceeding 20 μm from the one surface is also composed of the texture in which the fine precipitates are dispersed. In particular, in the case of each sample obtained from the cast material produced by continuous casting, a region extending from one surface to a position half the thickness of the sheet is composed of the texture in which the fine precipitates are dispersed. Here, only the region from the one surface is measured. However, it is speculated that from the foregoing results, a region extending from the other surface also has the texture in which the fine precipitates are dispersed, i.e., almost the entire region of the sample has the same texture. Furthermore, the samples with excellent corrosion resistance have small surface electrical resistance values after the corrosion test.

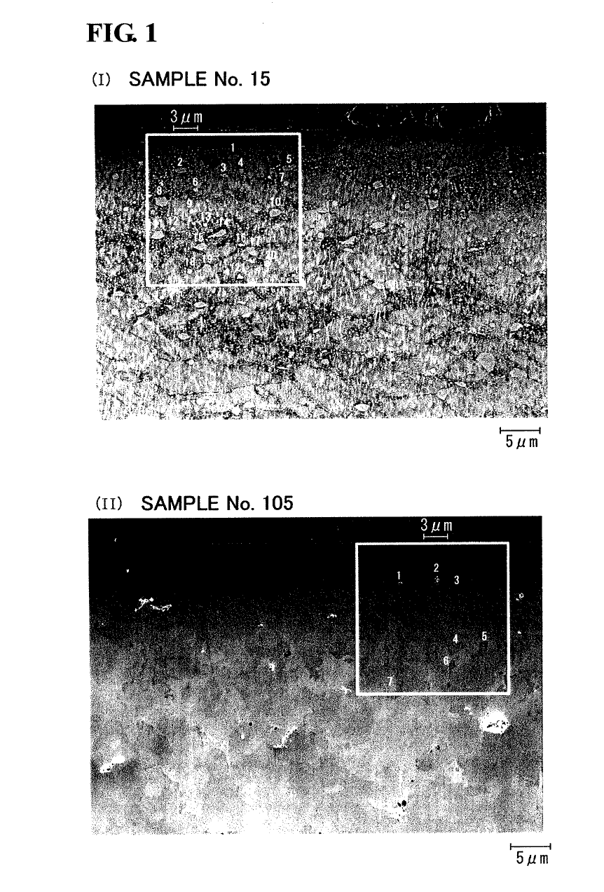

FIG. 1 illustrates scanning electron microscope photographs (×2000) of sample No. 15 and sample No. 105. In FIG. 1, upper black regions indicate backgrounds, gray regions indicate the samples, and small gray dots indicate precipitates. A 20 μm×20 μm subregion represented by a white frame is set in a region extending from a surface of each sample (from a boundary between the background and the sample) to a position 20 μm from the surface in the thickness direction. Precipitates present in each subregion are numbered. Part (I) of FIG. 1 demonstrates that sample No. 15 having excellent corrosion resistance is composed of the texture in which fine precipitates are dispersed in the surface area region. Furthermore, sample No. 15 having excellent corrosion resistance is composed of fine crystal grains. In contrast, for sample No. 105 having poor corrosion resistance, the surface area region has a small number of precipitates.

As described above, the samples each having the surface portion composed of the texture in which 10 or more fine precipitates are dispersed have excellent corrosion resistance. So, the samples do not need to be subjected to anticorrosion treatment. The P concentration (% by mass) in these samples are measured by Auger electron spectroscopy (AES) and found to be below the detection limit (0.01% by mass or less). This indicates that substantially no phosphorus (P), which is contained in an anticorrosion treatment agent, is contained.

The foregoing embodiments may be appropriately changed without departing from the scope of the present invention. The present invention is not restricted to the foregoing configurations. For example, the composition of the magnesium alloy and the thickness of the sheet after casting and after rolling may be appropriately changed. The resulting rolled material may be subjected to plastic working, e.g., press working or bending. A painted layer may be arranged directly on one surface.

### INDUSTRIAL APPLICABILITY

A magnesium alloy structural member according to the present invention has excellent corrosion resistance and is lightweight. Thus, the magnesium alloy structural member is suitably used for housings for mobile electronic devices and various members for transport machines, such as motor vehicles, trains, and airplanes.

### CITATION LIST

### Patent Literature

PTL 1: Japanese Unexamined Patent Application Publication No. 2007-098470

1. A magnesium alloy structural member comprising:
a base material composed of a magnesium alloy having an aluminum content of 4.5% by mass to 11% by mass,
wherein the base material has a pair of first and second surfaces, the first surface and the second surface being opposite each other,
wherein when a distance between the first surface and the second surface is defined as a thickness and when surface area regions are defined as regions extending from the first and second surfaces to positions 20 μm from the respective first and second surfaces in the thickness direction, in at least both the surface area regions, 10 or more fine precipitates are present in any 20 μm×20 μm subregion of each of the surface area regions, each of the fine precipitates containing both Mg and Al and having a greatest dimension of 0.5 μm to 3 μm.

2. The magnesium alloy structural member according to claim 1, wherein on each of the first and second surfaces, the proportion of a corroded area 100 hours after salt spray testing (Japanese Industrial Standards Z 2371, 2000) is 10% or less, and the surface electrical resistance value measured by a two-point probe method 100 hours after the salt spray testing is 30 Ω·cm or less.

3. The magnesium alloy structural member according to claim 1 or 2, wherein neither the first surface nor the second surface is subjected to anticorrosion treatment.

4. The magnesium alloy structural member according to claim 1, wherein the magnesium alloy structural member includes the base material and a painted layer that is arranged on only one of the first and second surfaces of the base material, and
wherein the painted layer is arranged directly on the one of the first and second surfaces.

5. The magnesium alloy structural member according to claim 1, wherein the concentration of phosphorus (P) on each of the first and second surfaces of the base material is 0.01% by mass or less.

6. The magnesium alloy structural member according to claim 1, wherein the magnesium alloy is one alloy selected from AZ61, AZ80, AZ81, and AZ91 alloys.

7. The magnesium alloy structural member according to claim 1, wherein the magnesium alloy structural member is a housing for an electronic device.

8. The magnesium alloy structural member according to claim 1, wherein the magnesium alloy structural member is a member for one transport machine selected from motor vehicles, railways, and airplanes.
